(19) United States
(12) Patent Application Publication
(10) Pub. No.: US 2005/0198360 A1
(43) Pub. Date: Sep. 8, 2005

(54) Apparatus and method for providing metered accounting of computer resources

(75) Inventors: Randall Lane Grimm, Rochester, MN (US); Paul Frederick Olsen, Rochester, MN (US)

Correspondence Address: MARTIN & ASSOCIATES, LLC;IBM INTELLECTUAL PROPERTY LAW DEPARTMENT, DEPARTMENT 917, BUILDING 006-1, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/753,519

(22) Filed: Jan. 8, 2004

(51) Int. Cl. G06F 15/16

(52) U.S. Cl. 709/233; 709/229

(57) ABSTRACT

An apparatus and method provide the capability of metering temporary capacity on demand in a computer system in a way that allows one resource to benefit from unused billed capacity of a different resource. The actual use of a selected resource is monitored. When the selected resource is actually used, before charging the customer for the resource, a check is made to see if there is unused billed capacity of another resource that may be used by the selected resource. If so, the unused billed capacity of the other resource is “stolen” and used by the selected resource. If there is no unused billed capacity of another resource, a resource-time increment is billed for the use of the selected resource.

### RELATED APPLICATION

This patent application is related to U.S. patent application “METHOD TO PROVIDE ON-DEMAND RESOURCE ACCESS”, Ser. No. 10/406,652 filed on Apr. 3, 2003, which is incorporated herein by reference.

### BACKGROUND OF THE INVENTION

1. Technical Field

This invention generally relates to data processing, and more specifically relates to utilization of resources in a computer system.

2. Background Art

Since the dawn of the computer age, computer systems have evolved into extremely sophisticated devices that may be found in many different settings. Computer systems typically include a combination of hardware (e.g., semiconductors, circuit boards, etc.) and software (e.g., computer programs). As advances in semiconductor processing and computer architecture push the performance of the computer hardware higher, more sophisticated computer software has evolved to take advantage of the higher performance of the hardware, resulting in computer systems today that are much more powerful than just a few years ago.

One problem with computer systems today is balancing the cost of the computer hardware with fluctuating demands on computer resources. In most networked computer systems, there are times when the computing demands are relatively low, and other times when the computing demands are very high. If a company purchases a computer system that is capable of meeting peak demand, much of the capacity of the computer system will go unused during non-peak times. In addition, purchasing capacity to meet peak demand is costly. If a company purchases a computer system that is capable of meeting average demand, the cost is lower, but the performance of the computer system suffers during peak times.

One way to provide a more flexible solution allows a computer user to buy a computer system that has some resources installed, but initially disabled. When the customer determines that more capacity is needed, the customer may enter into an arrangement with the provider of the computer system to enable certain resources for a fixed period of time. This works out particularly well for companies that have seasonal peaks. The companies can purchase a computer system at a reasonable cost that has the capability of providing enhanced computing power during the peak season. The concept of providing temporary capacity on demand is the subject matter of the related patent application “Method to Provide On-Demand Resource Access”, Ser. No. 10/406,652, filed on Apr. 3, 2003.

Referring to FIG. 2, a flow diagram of one known method 200 for providing temporary capacity on demand begins by the customer requesting an enablement code from the manufacturer (step 210). The customer receives the enablement code, which includes a specification of resource-time (step 220). The term “resource-time” is a general term that allows specifying any resource or combination of resources for any suitable period of time. One example of resource-time is processor-days. The customer enters the enablement code, which enables the resources on the computer system (step 230). A timer is then started (step 240). The user may then use the resources (step 250) as long as the resource-time has not expired (step 260=NO). Once the resource-time expires (step 260=YES), the resources are disabled (step 270).

A simple example will show the usefulness of method 200. Let's assume that a company that sells goods via catalog sales experiences peak demand in November and December of each year due to holiday shopping. The company could purchase a computer system that has one or more additional processors that are installed but initially disabled. The company may then contract with the provider of the computer system to enable the additional processor(s) for a set period of time. Let's assume that the computer system has two additional processors, and let's assume that the peak buying period runs for the thirty day period from November 15^{th} to December 14^{th}. The customer could purchase sixty processor-days of additional capacity beginning on November 15^{th}. These two additional processors will then be enabled for the thirty day period (providing the sixty processor-days of additional capacity). Once the sixty processor-days have elapsed, the two additional processors are disabled.

One problem with method 200 is the customer pays for the resource-time even though the resources may be used only a fraction of that time. For example, if the additional processors are used primarily during the eight hour day shift, the customer ends up paying for capacity that goes mostly unused during the other two shifts. In the example above, if the customer purchases sixty processor-days, and two processors are being enabled, these two processors are enabled for exactly thirty days regardless of workload during that time. While this is a vast improvement over previous systems that do not provide temporary capacity on demand, it still charges the customer for processor capacity that may go unused.

Another known way to charge for resource-time is to provide a fixed increment of resource-time, and to bill for the increment when each additional resource is used. For example, in many computer systems, a fixed number of base processors are defined to provide a baseline capacity, and additional processors may be put into service on-demand. Additional processors may be in a shared pool, and may be used at any time. Now the question becomes how to bill the customer for the use of additional processors. One prior art method 300 for charging a customer for the use of additional processors is shown in FIG. 3. First, the total processor usage (TPU) is determined (step 310). Next, the base processor usage is determined (step 320). If the total processor usage is less than or equal to the base processor usage (step 330=NO), the computer system is operating using only the base processors, so no additional charge need be made, and method 300 is done. If the total processor usage is greater than the base processor usage (step 330=YES), this means that one or more of the additional processors has been used. One of the additional metered processors is selected (step 340). If the selected metered processor has already been billed (step 350=NO), no additional charge needs to be made. If the selected metered processor is unbilled (step 350=YES), the customer is charged one processor-day for the selected metered processor (step 360). If there are more metered processors (step 370=YES), method 300 returns to step 340 to select the next metered processor, and the process continues until there are no more metered processors to consider (step 370=NO).

Prior art method 300 is preferably performed at defined time intervals (or time slices), such as once per minute. Prior art method 300 also assumes that the customer is charged in a defined resource-time increment, such as one processor-day. With these assumptions, the processor usage is monitored for each time slice, and if the processor usage exceeds the capacity provided by the base processors, an additional charge is made in step 360 for a full processor-day. Of course, if the processor usage in the next time slice exceeds the capacity provided by the base processors, no additional charge will be made for this processor because a full processor-day was charged in the previous time slice, so the additional processor is considered BILLED until the processor-day expires.

Charging a customer for a defined resource-time the first time that resource is used is a much better approach than charging the customer for a fixed resource-time regardless of whether or not the resource is used. However, even this approach results in billing the customer for time that may not actually be used, because a resource may be enabled for a full resource-time increment even though it is seldom used during that time increment. Without a way for billing a customer for resources in a manner that more accurately reflects actual usage, the computer industry will continue to suffer from inefficient ways of billing for temporary resources.

### DISCLOSURE OF INVENTION

An apparatus and method provide the capability of metering temporary capacity on demand in a computer system in a way that allows one resource to benefit from unused billed capacity of a different resource. The actual use of a selected resource is monitored. When the selected resource is actually used, before charging the customer for the resource, a check is made to see if there is unused billed capacity of another resource that may be used by the selected resource. If so, the unused billed capacity of the other resource is “stolen” and used by the selected resource. If there is no unused billed capacity of another resource, a resource-time increment is billed for the use of the selected resource.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of a computer apparatus in accordance with the preferred embodiments;

FIG. 2 is a flow diagram of a prior art method for providing temporary capacity on demand;

FIG. 3 is a flow diagram of a second prior art method for providing temporary capacity on demand;

FIG. 4 is a flow diagram of a method for providing temporary capacity on demand in accordance with the preferred embodiments;

FIG. 5 shows pseudo-code for one specific implementation of the method of FIG. 4;

FIG. 6 is a timing diagram showing processor utilization in a sample computer system for illustrating the concepts of the preferred embodiments;

FIG. 7 is a diagram showing how processor-days are billed for the processor utilization example shown in FIG. 6 using the prior art method in FIG. 3; and

FIG. 8 is a diagram showing how processor-days are billed for the processor utilization example shown in FIG. 6 using the method in accordance with the preferred embodiments shown in FIG. 4.

### BEST MODE FOR CARRYING OUT THE INVENTION

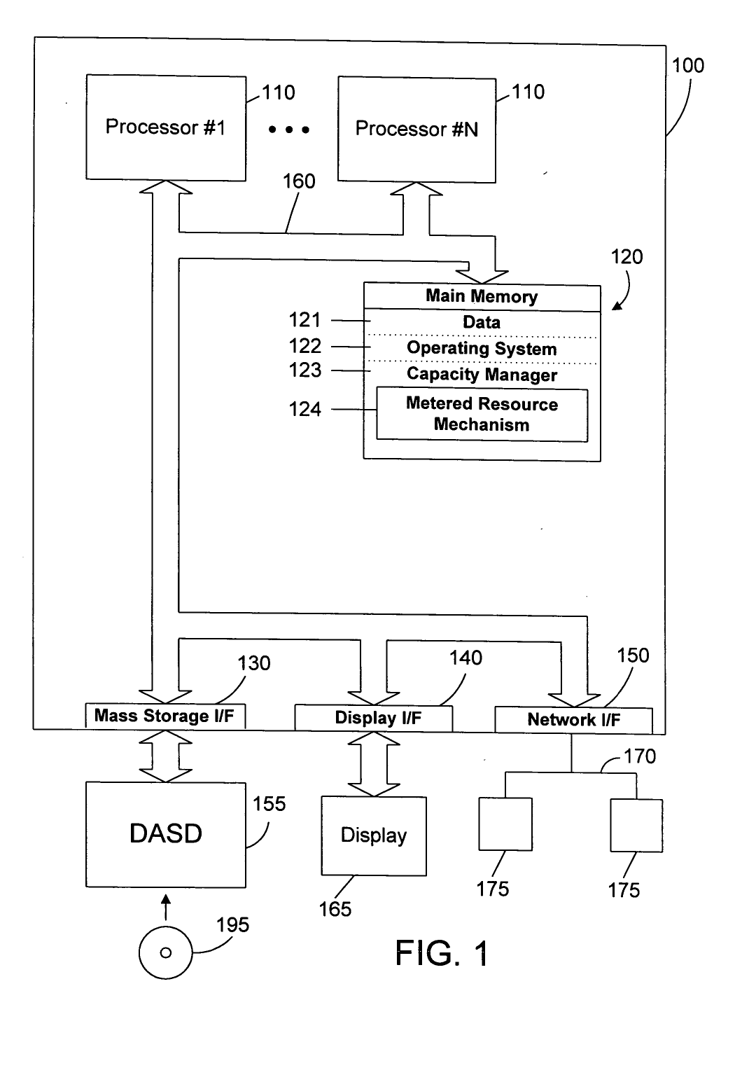

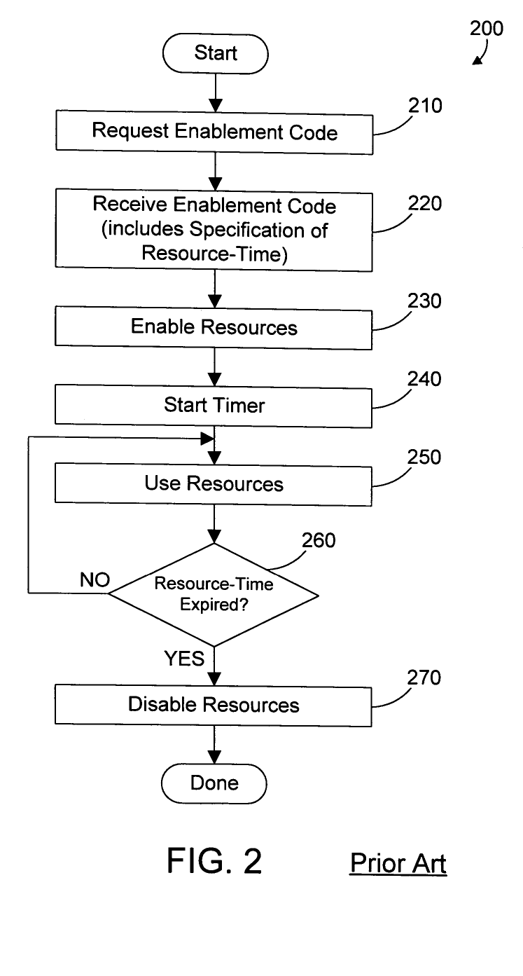

Referring to FIG. 1, a computer system 100 is an enhanced IBM eServer iSeries computer system, and represents one suitable type of computer system in accordance with the preferred embodiments. Those skilled in the art will appreciate that the mechanisms and apparatus of the present invention apply equally to any computer system. As shown in FIG. 1, computer system 100 comprises one or more processors 110 connected to a main memory 120, a mass storage interface 130, a display interface 140, and a network interface 150. These system components are interconnected through the use of a system bus 160. Mass storage interface 130 is used to connect mass storage devices (such as a direct access storage device 155) to computer system 100. One specific type of direct access storage device is a CD RW drive, which may read data from a CD RW 195.

Main memory 120 contains data 121, an operating system 122, and a capacity manager 123. Data 121 is any data that may be read or written by any processor 110 or any other device that may access the main memory 120. Operating system 122 is a multitasking operating system, such as OS/400, AIX, or Linux; however, those skilled in the art will appreciate that the spirit and scope of the present invention is not limited to any one operating system. Any suitable operating system may be used. Operating system 122 is a sophisticated program that contains low-level code to manage the resources of computer system 100. Some of these resources are processor 110, main memory 120, mass storage interface 130, display interface 140, network interface 150, and system bus 160.

Capacity manager 123 provides metered capacity on demand using an accounting method that allows one resource to use unused billed time of a similar resource. The capacity manager 123 includes a metered resource mechanism 124 that implements the accounting method of the preferred embodiments.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, data 121, operating system 122, and capacity manager 123 are shown to reside in main memory 120, those skilled in the art will recognize that these items are not necessarily all completely contained in main memory 120 at the same time. It should also be noted that the term “memory” is used herein to generically refer to the entire virtual memory of computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up the operating system 122.

Although computer system 100 is shown to contain only a single system bus, those skilled in the art will appreciate that the present invention may be practiced using a computer system that has multiple buses. In addition, the I/O interfaces that are used in the preferred embodiment each may include separate, fully programmed microprocessors that are used to off-load compute-intensive processing from processor 110, as in iSeries input/output processors, or may be simple industry standard I/O adapters (IOAs).

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer readable signal bearing media used to actually carry out the distribution. Examples of suitable signal bearing media include: recordable type media such as floppy disks and CD RW (e.g., 195 of FIG. 1), and transmission type media such as digital and analog communications links.

The preferred embodiments apply to metering of temporary resources in any computer system, including computer systems that have multiple logical partitions. Temporary resources (such as processors) are typically made available in a group known as a “pool” in a logically partitioned computer system. Any logical partition may use any processor in the pool of available processors. In a logically partitioned computer system, accounting for resource usage requires summing resource usage across logical partitions. The preferred embodiments provide an effective way to account for metered resources in a logically partitioned computer system because the preferred embodiments operate on the aggregate total of resource usage across all logical partitions.

The preferred embodiments herein discuss processors as one particular example of a metered resource, but expressly extend to any and all computer system resources that may be metered.

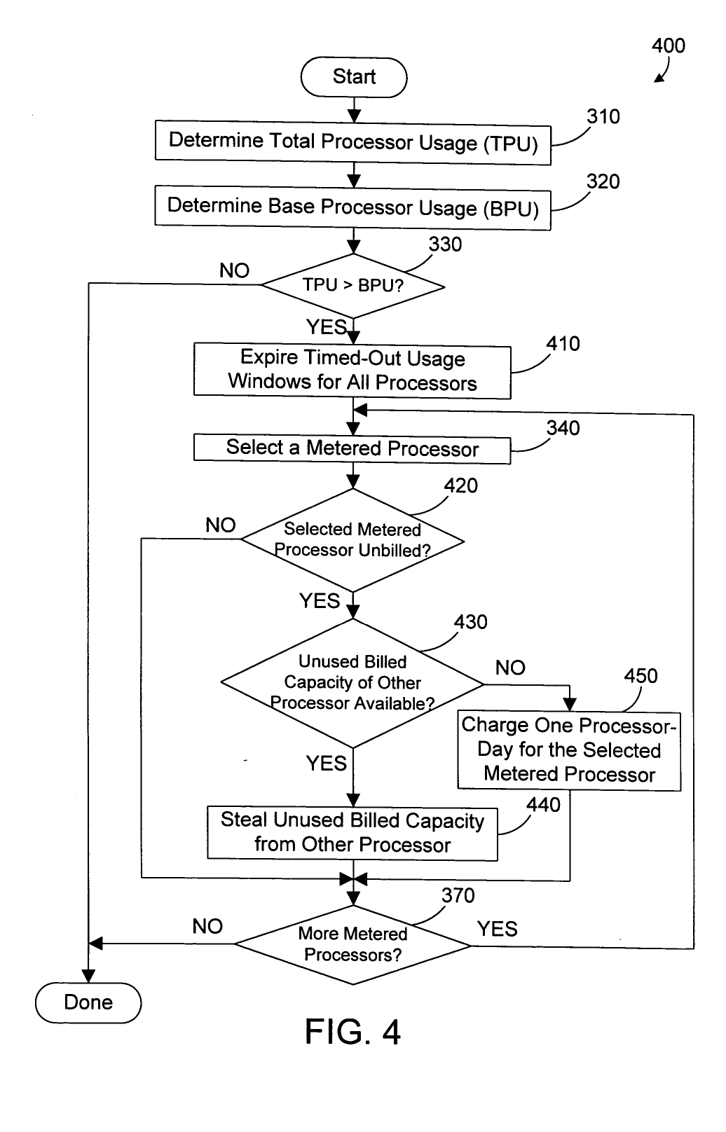

Referring now to FIG. 4, the preferred embodiments accumulate processor usage during a defined time slice, then determine based on that usage whether the customer needs to be billed for metered resources. Method 400 in FIG. 4 begins by determining total processor usage (step 310). In the case of a logically partitioned computer system, total processor usage is the sum of processor usage from all logical partitions. Next, the base processor usage is determined (step 320). If the total processor usage is less than or equal to the base processor usage (step 330=NO), the computer system is operating using only the base resources, so no additional charge needs to be made for metered resources. If the total processor usage exceeds the base processor usage (step 330=YES), method 400 expires all timed-out usage windows for all processors (step 410). This means that if a usage window (e.g., processor-day) expired during the last time slice, it will be recognized as expired in step 410. Next, a metered processor is selected (step 340). If the selected metered processor has already been billed (step 420=NO), there is no need to bill for the selected metered processor. If the selected metered processor is unbilled (step 420=YES), method 400 determines whether there is another processor that has unused billed capacity available (step 430). If so (step 430=YES), method 400 steals the unused billed capacity from the other processor and applies it to the selected metered processor (step 440). If there is no unused billed capacity available (step 430=NO), method 400 charges one processor-day for the selected metered processor (step 450). Step 370 then determines whether there are more metered processors to consider. If so (step 370=YES), method 400 loops back to step 340 and continues. If not (step 370=NO), method 400 is done. By allowing one resource to use unused billed capacity of another resource, the customer is billed less than using prior art system that account for usage of temporary resources.

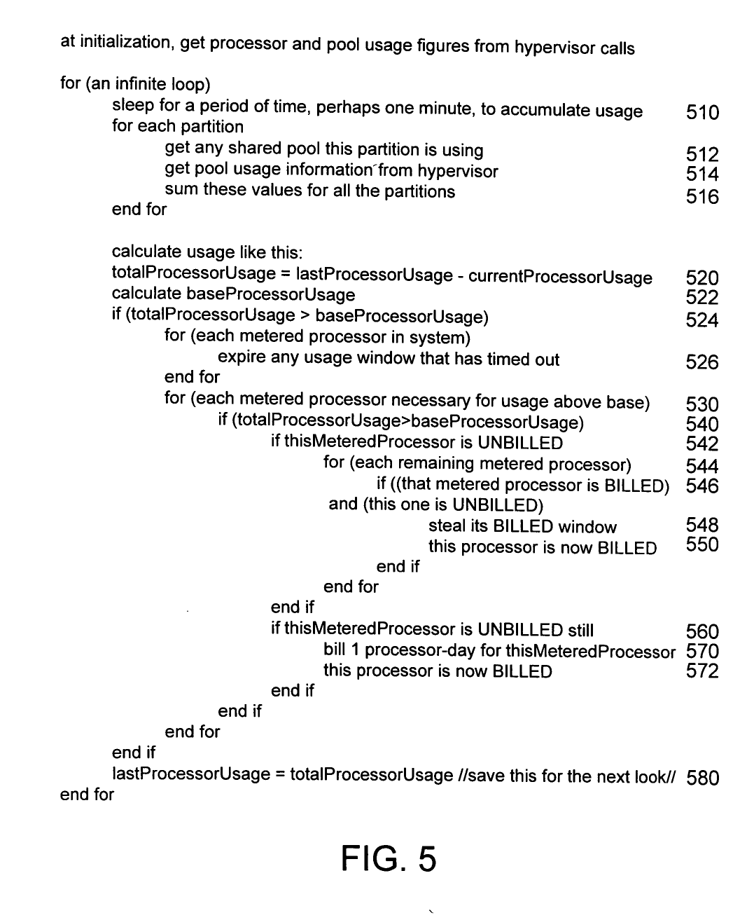

FIG. 5 shows pseudo-code that is one specific implementation in accordance with method 400 in FIG. 4. This pseudo-code assumes a logically partitioned computer system that includes a hypervisor that manages the logical partitions. The hypervisor provides the processor and pool usage data. The first step at line 510 is to sleep for some time slice to accumulate usage data. Then, for each partition, the shared pool for the partition is determined at line 512, the pool usage information is retrieved from the hypervisor at line 514, and these values are summed for all the logical partitions at line 516. The totalProcessorUsage is then calculated by subtracting the currentProcessorUsage from lastProcessorUsage at line 520. This provides the total processor usage during the time slice. The baseProcessorUsage for this time slice is then calculated at line 522. If the totalProcessorUsage during this time slice exceeds the baseProcessorUsage for this time slice at line 524, all metered processor usage windows that have timed out are expired at line 526 for each metered processor in the system. Then, for each metered processor that is necessary to cover the usage above the base processor usage (at line 530), if the totalProcessorUsage is greater than the baseProcessorUsage at line 540, and if thisMeteredProcessor is UNBILLED at line 542, each of the other metered processors are considered at line 544. If a metered processor is BILLED and the currently-selected metered processor is UNBILLED at line 546, the selected metered processor steals the BILLED window of the other processor at line 548. The selected metered processor is then marked as BILLED at line 550. If there is no BILLED capacity of another processor that may be stolen by (or assigned to) the current processor, thisMeteredCapacity will be UNBILLED at line 560, which results in one processor-day being billed at line 570. This processor is now considered BILLED at line 572. At the end, the totalProcessorUsage is saved as the lastProcessorUsage at line 580 so this may be used during the next time slice.

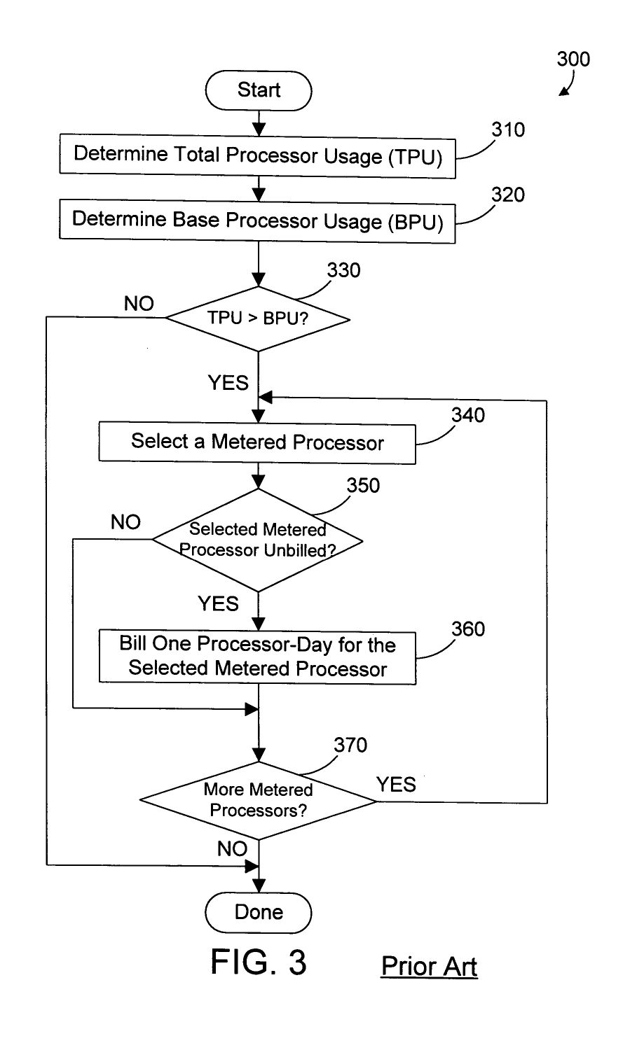

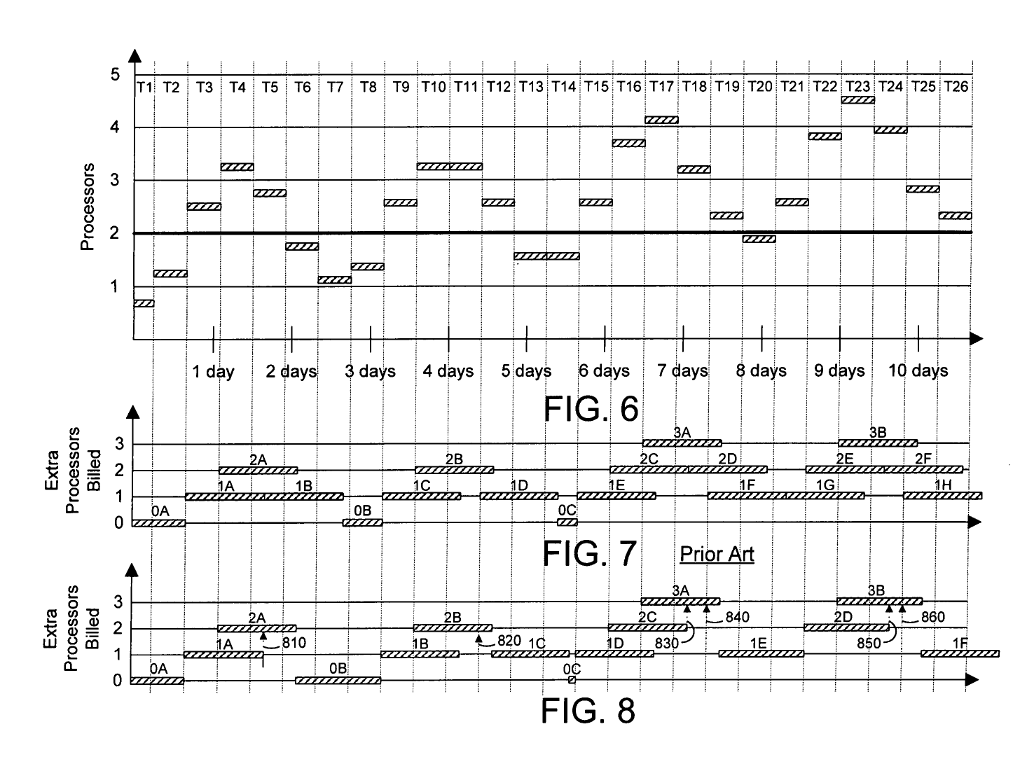

An example is now presented to show how the metered resource accounting of the preferred embodiments differs from the metered resource accounting known in the art. The graph of FIG. 6 shows processor usage levels for defined time slices. The magnitude of each time slice in FIG. 6 is artificially large to allow graphic illustration of the principles of the preferred embodiments. Each time slice is labeled incrementally from T1-T26. We assume for this example that two processors are the base capacity of the computer system, as shown by the bold horizontal line in FIG. 6. Any use equal to or less than two processors incurs no additional charge, while use above two processors is charged in one processor-day increments. Using the prior art method of FIG. 3, the metered (or additional) processor are billed as shown in FIG. 7. In time periods T1 and T2, no extra processors are billed because the total processor utilization in FIG. 6 is less than two in both of these time periods, as shown at 0A in FIG. 7. In time period T3, the total processor utilization is greater than the base processor utilization, so the first metered processor is billed one processor-day, as shown at 1A in FIG. 7. In time period T4, the total processor utilization now requires two additional processors as shown in FIG. 6. As a result, the second extra processor is billed for one processor-day at 2A in FIG. 7. In time period T5, only one extra processor needs to be billed. However, the one processor-day for the first extra processor expires during T5, so another processor-day for the first extra processor must be billed at 1B in FIG. 7. During time period T6, the total processor utilization goes below the 2 base processor level, so the extra processor-day purchased at 1B goes unused during T6 and a portion of T7. Once the processor-day at 1B expires, no additional processors are required, as shown at 0B in FIG. 7, which spans the end of T7 and all of T8. At time period T9, the total processor utilization again exceeds the two processor base level, so one processor-day is billed at 1C in FIG. 7. During time periods T10 and T11, two additional processors are needed, so the second extra processor is billed another processor-day at 2B in FIG. 7. At time period T12, the processor-day for the first period has expired, and one extra processor is still required, so the first extra processor is billed another processor-day, as shown at 1D in FIG. 7. At times T13 and T14, the total processor utilization drops below the two processor base level, so the extra capacity at 1D during T13 and a portion of T14 goes unused. Once the processor-day at 1D expires, there are no extra processors billed at 0C in FIG. 7.

At time period T15, one extra processor is again required, so another processor-day is billed for the first extra processor at 1E. At time period T16, two extra processors are required, so a processor-day is billed for the second extra processor at 2C. At time period T17, three extra processors are required, so a processor-day is billed for the third extra processor at 3A. During time period T18, the processor-day at 2C expires, so another processor-day at 2D must be billed because two additional processors are still needed during T18. During time period T19, only one extra processor is needed, but the one processor-day window at 1E has already expired, so another processor-day for the first extra processor is billed at 1F. The total processor utilization during time period T20 drops below the baseline two processor level, but the processor-day at 1F has already been billed, so the extra capacity during T20 goes unused. During time period T21, one additional processor is needed. Note, however, that partway through T21, the window for 1F expires, which requires another processor-day at 1G to be billed. At time period T22, two extra processors are needed, so the second additional processor is billed for a processor-day at 2E. During time period T23, three additional processors are needed, so the third extra processor is billed for one processor-day at 3B in FIG. 7. During time period T24, the total processor utilization drops to only needing two extra processors. However, the one processor-day window for 2E expires part way through time period T24, which requires another processor-day to be billed at 2F. During time period T25, the total processor utilization drops to only require one additional processor. However, the first additional processor's last processor-day period expired at the end of I G, so another processor-day must be billed at 1H. The result of the prior art system of billing for extra processor-days results in eight processor-days for the first extra processor, six processor-days for the second extra processor, and two processor-days for the third extra processor, for a total of 16 processor-days billed, as shown in FIG. 7.

The preferred embodiments improves upon the prior art method of billing for extra processors by looking to see if there is unused billed capacity for another processor that can be assigned to (or used) by a different processor. Referring to FIG. 8, the no billing for extra processors at 0A, the billing for one processor-day at 1A, and the billing for one processor-day at 2A are the same as in FIG. 7. Note, however, that during T5, when the processor-day at 1A expires, the method of the preferred embodiments, before billing another processor day (as shown at 1B in FIG. 7), first looks to see if there is billed unused capacity that another processor has that can be used. At point 810 in FIG. 8, it is determined that the processor-day billed at 2A is unused, so the remaining portion of the processor-day at point 810 may be assigned to and used by the first processor, resulting in no need for the first processor to be billed for another processor-day. This occurs again at 820, with the unused billed portion of 2B being used by the first processor. Note, however, that when 2B expires, another processor-day is still needed at 1C.

At 830 in FIG. 8, the unused processor capacity for 3A that was already billed may be used by the second processor. Then at 840, the remaining unused processor capacity for 3A may be used by the first processor. Note that when 3A expires, the first processor is billed another processor-day at 1E because there is a need during time period T19 for one additional processor. At 850, the second processor uses the unused billed portion of 3B instead of billing another processor-day, and at 860 the first processor uses the unused remaining billed portion of 3B instead of billing another processor-day. Of course, because an additional processor is required in time period T25, the first processor must be billed a processor-day at 1F once the processor-day at 3B expires.

The processor-days billed in FIG. 8 are six processor-days for the first extra processor, four processor-days for the second extra processor, and two processor-days for the third extra processor, for a total of 12 processor-days, as shown in FIG. 8. When compared to the 16 processor-days billed in FIG. 7, the result is a significant 25% reduction in billed processor-days by simply changing the accounting method to recognize when another processor has unused billed capacity that may be used by another processor. The result is the customer pays for fewer processor-days and thus receives the same computing power at a lower cost.

The specific examples presented herein refer to processors and processor-days by way of example of suitable computer system resources and resource-times. The preferred embodiments expressly extend to any suitable computer system resources and any suitable denomination of resource-time.

The methods herein refer to billing for a specified resource-time, such as a processor-day. Note that the preferred embodiments encompass any and all suitable billing systems. In one such system, the accumulated resource-time is billed to the customer by the computer system supplier. In a different such system, the billed resource-time is deducted from a prepaid amount. The term “bill” as used herein simply means that the customer becomes liable for payment for one resource-time unit, regardless of the specific arrangement for payment between supplier and customer.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

1. An apparatus comprising:
at least one processor;
a memory coupled to the at least one processor;
a plurality of resources coupled to the at least one processor that provides temporary capacity on demand; and
a capacity manager residing in the memory and executed by the at least one processor, the capacity manager managing access to the plurality of resources, the capacity manager determining when a selected one of the plurality of resources is required, and when the selected resource is required, the capacity manager determining whether unused billed capacity for a similar resource is available, and if so, the capacity manager assigning the unused billed capacity of the similar resource to the selected resource.

2. The apparatus of claim 1 wherein the capacity manager bills a predetermined resource-time for the selected resource if no unused paid capacity for a similar resource is available.

3. The apparatus of claim 2 wherein the capacity manager deducts the billed predetermined resource-time from a prepaid amount.

4. The apparatus of claim 1 wherein the capacity manager further determines whether the selected resource has already been billed.

5. An apparatus comprising:
at least one processor;
a memory coupled to the at least one processor;
a plurality of logical partitions defined on the apparatus;
at least one resource that provides temporary capacity on demand; and
a capacity manager residing in the memory and executed by the at least one processor, the capacity manager managing access to a selected resource, the capacity manager performing the steps of:
determining when the selected resource is required;
determining whether the selected resource has already been billed;
if the selected resource has not already been billed, determining whether unused billed capacity for a similar resource is available;
if unused billed capacity for a similar resource is available, assigning the unused billed capacity of the similar resource to the selected resource; and
if unused billed capacity for a similar resource is not available, billing a predetermined resource-time for the selected resource.

6. The apparatus of claim 5 wherein the capacity manager deducts the billed predetermined resource-time from a prepaid amount.

7. A computer-implemented method for providing metered capacity of at least one resource on demand, the method comprising the steps of:
determining when a selected resource is required;
when the selected resource is required, determining whether unused billed capacity for a similar resource is available; and
if unused billed capacity for a similar resource is available, assigning the unused billed capacity of the similar resource to the selected resource.

8. The method of claim 7 further comprising the step of billing a predetermined resource-time for the selected resource if no unused paid capacity for a similar resource is available.

9. The method of claim 8 further comprising the step of deducting the billed predetermined resource-time from a prepaid amount.

10. The method of claim 7 further comprising the step of determining whether the selected resource has already been billed.

11. A computer-implemented method for providing metered capacity of at least one resource on demand, the method comprising the steps of:
determining when the selected resource is required;
determining whether the selected resource has already been billed;
if the selected resource has not already been billed, determining whether unused billed capacity for a similar resource is available;
if unused billed capacity for a similar resource is available, assigning the unused billed capacity of the similar resource to the selected resource; and
if unused billed capacity for a similar resource is not available, billing a predetermined resource-time for the selected resource.

12. The method of claim 11 further comprising the step of deducting the billed predetermined resource-time from a prepaid amount.

13. A program product comprising:
a capacity manager that manages access to a plurality of computer system resources, the capacity manager determining when a selected one of the plurality of resources is required, and when the selected resource is required, the capacity manager determining whether unused billed capacity for a similar resource is available, and if so, the capacity manager assigning the unused billed capacity of the similar resource to the selected resource; and
computer readable signal bearing media bearing the capacity manager.

14. The program product of claim 13 wherein the signal bearing media comprises recordable media.

15. The program product of claim 13 wherein the signal bearing media comprises transmission media.

16. The program product of claim 13 wherein the capacity manager bills a predetermined resource-time for the selected resource if there is no unused paid capacity for a similar resource available.

17. The program product of claim 16 wherein the capacity manager deducts the billed predetermined resource-time from a prepaid amount.

18. The program product of claim 13 wherein the capacity manager further determines whether the selected resource has already been billed.

19. A program product comprising:
(A) a capacity manager managing access to a selected computer system resource, the capacity manager performing the steps of:
determining when the selected resource is required;
determining whether the selected resource has already been billed;
if the selected resource has not already been billed, determining whether unused billed capacity for a similar resource is available;
if unused billed capacity for a similar resource is available, assigning the unused billed capacity of the similar resource to the selected resource; and
if unused billed capacity for a similar resource is not available, billing a predetermined resource-time for the selected resource; and
(B) computer readable signal bearing media bearing the capacity manager.

20. The program product of claim 19 wherein the signal bearing media comprises recordable media.

21. The program product of claim 19 wherein the signal bearing media comprises transmission media.

22. The program product of claim 19 wherein the capacity manager deducts the billed predetermined resource-time from a prepaid amount.
